(19) United States
(12) Patent Application Publication
(10) Pub. No.: US 2015/0024285 A1
(43) Pub. Date: Jan. 22, 2015

(54) Mini-fuel cells for battery-powered devices

(71) Applicant: Michael Lewis Moravitz, Fairfax, VA (US)

(72) Inventor: Michael Lewis Moravitz, Fairfax, VA (US)

(21) Appl. No.: 14/121,537

(22) Filed: Sep. 30, 2014

(51) Int. Cl. H01M 8/00

(52) U.S. Cl. CPC H01M 8/002; H01M 2250/30
USPC 429/400

(57) ABSTRACT

Mini-fuel cells for small devices.

Mini-fuel cells, like the chemical reactive cells in Hybrid vehicles, may power small devices in the home that now use batteries. Mini-fuel cells—developed from current fuel cell batteries for Hybrid vehicles—could be used for remote controls, flashlights, calculators, and potentially any other device that currently using alkaline batteries—a technology that is more than 110 years old.

According to Wikipedia, “A fuel cell is a device that converts the chemical energy from a fuel into electricity through a chemical reaction with oxygen or another oxidizing agent . . . . Fuel cells are different from batteries in that they require a continuous source of fuel and oxygenair to sustain the chemical reaction whereas in a battery the chemicals present in the battery react with each other to generate an emf. Fuel cells can produce electricity continuously for as long as these inputs are supplied.” In other words, there might be two chambers in the battery, in which water or another agent moves continuous through—or the fuel cell in essence has the reactive agents together in such a way that the energy lasts sufficiently long to be cost-effective. In fact, even s small radioactive fuel cells—using a radioactive element with an oxidizing agent in a chemical reaction that produces energy—might be appropriate for home use—if encased in appropriate material.

1. Builds on claims for fuel cells and alkaline batteries.
